(19) United States
(12) Patent Application Publication
(10) Pub. No.: US 2009/0096574 A1
(43) Pub. Date: Apr. 16, 2009

(54) RFID TAG USING ENCRYPTED PASSWORD PROTECTION

(75) Inventor: Robert R. Oberle, Macungie, PA (US)

Correspondence Address: FLIESLER MEYER LLP, 650 CALIFORNIA STREET, 14TH FLOOR, SAN FRANCISCO, CA, 94108, US

(73) Assignee: RCD TECHNOLOGY, INC., QUAKERTOWN, PA (US)

(21) Appl. No.: 12/255,527

(22) Filed: Oct. 21, 2008

Related U.S. Application Data
(63) Continuation-in-part of application No. 12/131,271, filed on Jun. 2, 2008.
(60) Provisional application No. 60/980,249, filed on Oct. 16, 2007.

(51) Int. Cl. G06F 7/04

(52) U.S. Cl. 340/5.8

(57) ABSTRACT

A permanent ID can be read off of an RFID chip of an RFID tag. The permanent ID can be combined with a seed value to form a combined value. The combined value can be encrypted to form an encrypted value. This encrypted value can be stored on the RFID chip. Later, the RFID tag can be validated using the encryption value.

### CLAIM OF PRIORITY

This application is a Continuation-in-Part to U.S. Utility application Ser. No. 12/131,271, entitled “RFID TAG USING ENCRYPTION VALUE”, by Robert R. Oberle, filed on May 2, 2008 [Atty. Docket No. RCDT-01022US1], which claims priority to U.S. Provisional Application No. 60/980,249, entitled “RFID TAG USING ENCRYPTED VALUE” by Robert R. Oberle, filed Oct. 16, 2007 [Atty. Docket No. RCDT-01022US0], which is hereby incorporated by reference.

### BACKGROUND

A problem that can occur for product distribution is that of unauthorized copies of products. For example, a contract manufacture can receive the specifications for a product from a designer and make a number of authorized products. Unscrupulous manufacturers can then go on to make additional unauthorized, but identical, copies of the product to sell illegally at a high profit.

One way to get around this issue is by using a RFID tag that can encrypt and decrypt data. In this way, the integrity of products can be assured.

### SUMMARY OF THE INVENTION

The problem with using present RFID tags to secure articles is that the cost of such RFID tags for authentication can be relatively large. This is because the present state of the art is to use tags with a large block of encrypted memory to describe the article, or to utilize an off line database to store attributes of the tagged article. In the former case the protocol for decrypting the stored information are complex and often require expensive and specially configured RFID readers, in the second case maintenance and upkeep of the database as well as insuring real time access have proven to be difficult logistical tasks.

Embodiments of the present invention include ways to use the less expensive RFID tags in an encryption and authentication scheme. Encryption and decryption can be done outside the RFID tag.

Embodiments of the present invention a permanent ID that RFID chip manufacturers typically put a on the RFID chip in combination with additional data that is provided by an authenticating authority (typically the legitimate manufacturer). Since this permanent ID is added in the chip manufacture process, it is impractical to spoof. The additional data is known to the authenticating authority and may be recovered from data written to the RFID tag memory.

The permanent ID and additional data, together the authentication data, can be encrypted then the encrypted value can be stored back onto another location on the RFID chip of the RFID tag. Validation can include decryption of the encrypted value and the comparing of the decrypted value with the authentication data.

A person who wanted to spoof the RFID tag would need to have access to the encryption algorithm. Merely copying data for a previous RFID chip would not be sufficient, since when decrypted, the decrypted version of the permanent ID would not match the permanent ID placed on the RFID chip by the RFID manufacturer.

### BRIEF DESCRIPTION OF FIGURES

FIG. 1 is a flow chart illustrating an encryption method of one embodiment of the present invention.

FIG. 2 is a flow chart illustrating a decryption method of one embodiment of the present invention.

FIG. 3 illustrates an RFID chip of one embodiment of the present invention

FIGS. 4A and 4B illustrate a method of using an RFID tag of one embodiment.

FIG. 5 illustrates embodiments using decryption.

FIG. 6 shows an exemplary RFID tag with a password protection section of memory.

FIG. 7 shows an extension method using Rolling Code and an RFID tag with a password protected section of memory.

### DETAILED DESCRIPTION OF THE INVENTION

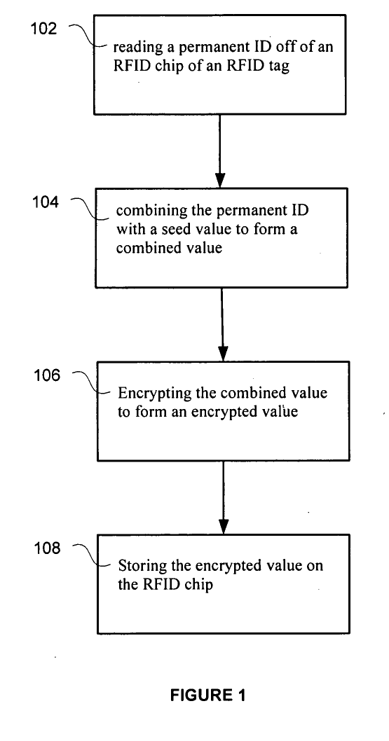

One embodiment of the present invention, as shown in FIG. 1, is a method comprising in step 102, reading a permanent ID, such as a Unique Identification (UID), off of an RFID chip of an RFID tag. In step 104, combining the permanent ID with a seed value to form a combined value. In step 106, encrypting the combined value and the seed value to form encrypted values. In step 108, storing the encrypted values on the RFID chip. The RFID tag can be authenticated using the encrypted values.

The combination can be any type of combination including the permanent value and seed value. This can include operations such as addition, subtraction and multiplication, bit shifting, Boolean operations, bit reversal, padding, truncation etc.

The RFID tag can be authenticated by decrypting the encrypted values to obtain the permanent ID and the seed value.

The derived permanent ID obtained using the encrypted value can be compared to the permanent ID off of the RFID chip. The seed value determined from the encryption value can also be validated.

The RFID chip can also include product data.

The seed value can be obtained from a pool of seed values. In one embodiment, the writing of the encrypted value to the RFID chip can be done by an RFID reader, and this RFID reader can maintain the pool of seed values.

Public/private key encryption can be used. For the purpose of following discussion, the terms public and private keys are used for convenience. The system architect may choose to publish the “private” key and keep the “public” key secret. The encrypted value can encrypted with a public key. The encrypted value can then be decrypted by a private key. Alternately, any other encryption/decryption scheme can be used.

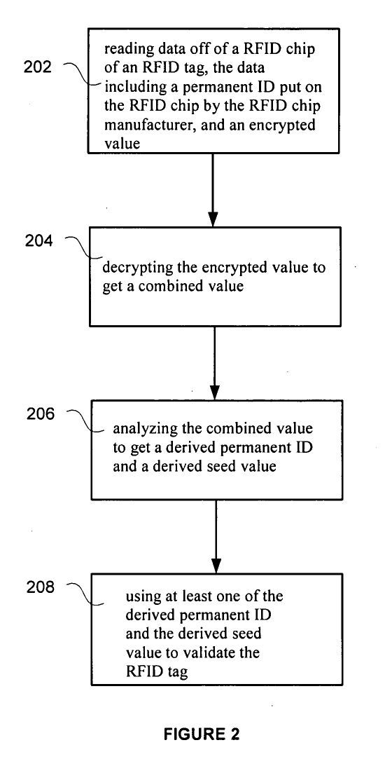

FIG. 2 is a flow chart illustrating a decryption method of one embodiment of the present invention. In step 202, data is read off of a RFID chip of an RFID tag. The data including a permanent ID put on the RFID chip by the RFID chip manufacturer, and an encrypted value.

In step 204, the encrypted value is decrypted to get a combined value. In step 206, the combined value is analyzed to get a derived permanent ID and a derived seed value.

In step 208, using at least one of the derived permanent ID and the derived seed value to validate the RFID tag. The validation can include comparing the derived permanent ID portion obtained from the encrypted value with the permanent ID put on the RFID chip by the RFID manufacturer. The validation can include analyzing the derived seed value.

In one embodiment, the seed values are encrypted. The derived seed value can be decrypted to determine if the derived seed value is valid.

The encrypted values can be encrypted with a public key and the decryption uses a private key.

The method of FIG. 2 can be done by an RFID reader.

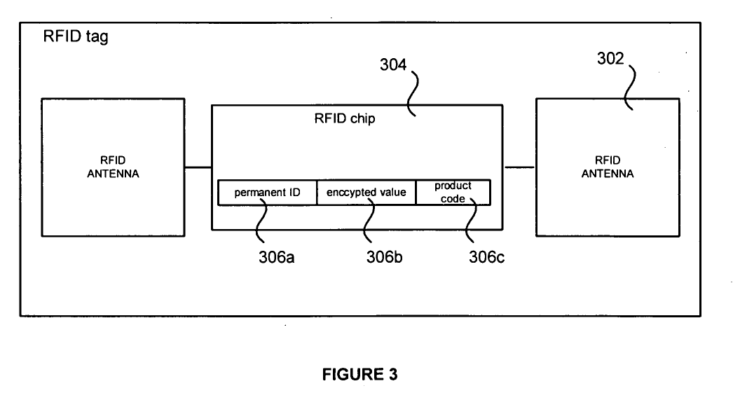

FIG. 3 shows a RFID tag comprising an RFID antenna 302 and an RFID chip 304. The RFID chip can include a permanent ID 306a put on the RFID chip 304 by the RFID chip manufacturer, and an encrypted value 306b written to the RFID chip by an RFID reader. The encrypted value 306b can be created by encrypting a combined value. The combined value can combine the permanent ID and a seed value. The RFID chip 304 can further store product data 306c.

The RFID reader 402 can be configured through software to authenticate an RFID tag through the use of a public/private key encryption method. The public key can be stored on removable media. The stored public key can be encrypted or password protected such that the user must enter data in order to access the public key. The public key can be stored locally on the reader in re-writable memory, or non-re-writable memory.

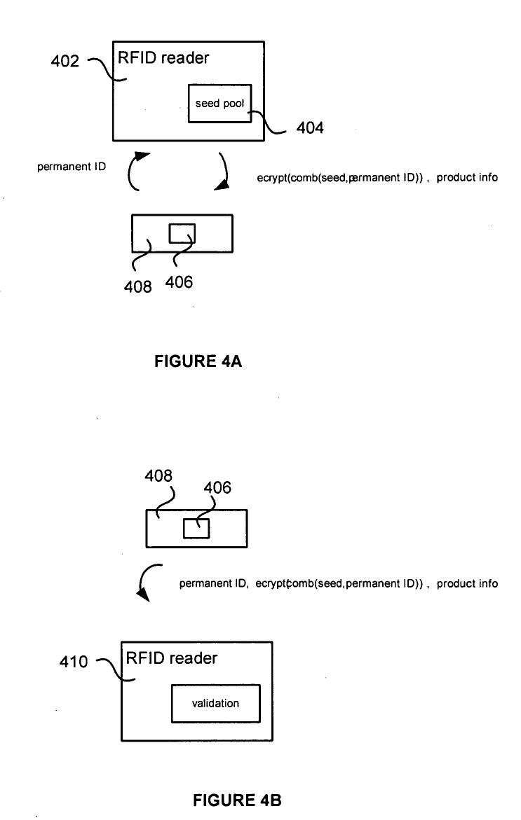

FIG. 4A shows an example of the operation of one embodiment. A RFID reader 402 can have a pool 404 of seed values. The RFID reader 404 can interrogate the RFID chip 406 and get the permanent ID. This permanent ID is combined with a seed value from the seed pool 404, and the combined value is encrypted to form an encrypted value. The encrypted value, and optionally product data, is written to the RFID chip 406 on the RFID tag 408.

Later, as shown in FIG. 4B, the RFID tag 408 can be integrated by another RFID reader 410. The seed and derived permanent ID can then be obtained and validated. The RFID reader 410 can be at a location such as US customs, a repair center or a store.

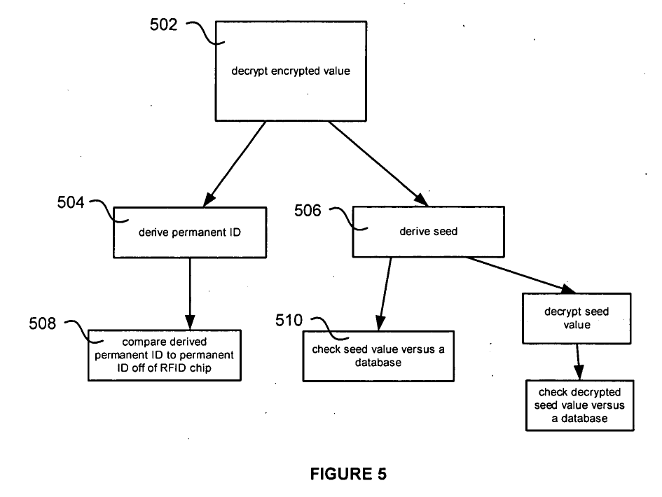

FIG. 5 shows details of validation of one embodiment. In step 502, the encryption value is used to get a derived permanent ID 504 and derived seed 506.

The derived permanent ID can be compared to the permanent ID on the chip in step 508. If a spoofed value is used, then the derived permanent ID will not match the real permanent ID.

The derived seed 506 can be checked against remote or local database. Alternately, the derived seed value can be decrypted and then compared against a remote or local database.

The present system can prevent counterfeit product from getting into the supply chain and/or detect counterfeits at any of a number inspection point inside or outside of their control. RFID tags can be used to validate if a shipment is counterfeit at a customs inspection point or other locations. A potential rogue contract manufacturer (CM) can be prevented using the technology from producing electronically verifiable fakes.

A method can be as follows:
1) A company can provide labels for the CM, potentially directly from a trusted partner, without the company ever seeing them.
2) Upon validation by the CM that an order is ready to ship, the company can provide the CM with an encrypted file with a set of seed values that correspond one to one with the number of products to be shipped. This can be done through a trusted partner.
3) RFID Reader middleware can decrypt the file and obtain the seed values.
4) The RFID Reader can obtain the permanent ID (UID) from the tag
5) The RFID Reader can perform a defined mathematical operation on the seed value and the UID of one tag (such as addition, bit shift then add, etc. . . . ). This mathematical operation can be defined by the seed value itself, i.e. add for seed numbers ending in 7, bit shift with seed numbers ending in 5 etc. . . .
6) The RFID Reader can encode the result from 5 above and the seed value using a company provided public key, and can write the resultant to defined fields in the tag memory,
7) The RFID Reader may also encode other data as desired by the designer, this may be password protected or not as desired by the designer, a date stamp can also be desirable,
8) In one embodiment, the RFID Reader validates the tag data stream but not the content,
9) Tag can be attached to the product and shipped.

At customs or other location;
a) A company provided reader with embedded middleware can use the company private key to decrypt the data from step 6 above,
b) Reader can perform the known mathematical operation from 5 above on the permanent ID (UID) and decrypted seed value, and checks to see if the results match the decrypted data,
c) If they match, the product can be validated as genuine, if not goes to quarantine.

The designer can control the private key and agreed not share it with the contract manufacturer, thus they control the validation. Potentially the trusted partner could do this as a service. Even if the contract manufacturer knows the mathematical operation the designer controls the seed values which are traceable by manufacturer.

The date stamp can be useful either as a way to shift the public/private key sets or can be combined with the seed value (mathematically) at the time of encryption. This only becomes an issue if the private key becomes compromised.

As described above, one method for providing self authentication of an RFID tag to a properly configured reader can utilize the following steps to encode the tag:

1) Read the static tag identification number (TID) from the RFID tag

2) Mathematically combine the TID with a second unique value (S) provided by a trusted authentication source to form an authentication string (AS)

3) Encrypt the variables AS and S using a user specific encryption key

4) Writing the encrypted data, AS*, to the tag

The tag may be authenticated through the following series of operations

1) Read the encrypted data, AS* and the plain text TID from the tag

2) Decrypt the data using the user's decryption key to obtain AS

3) Invert the mathematical combination of AS to obtain S*

4) Recalculate AS** from the TID and S*

5) Compare AS** and AS

If the two values AS** and AS match the tag is authentic. The actual computational path is chosen because of its simplicity not because it is the only computational path to authenticate the data.

While this approach is applicable to passive tags it may suffer from one known security drawback, that of a so-called replay attack. This attack is one in which a counterfeit tag or tag emulator replays the entire data string of a known authentic tag, after being queried by an RFID reader. The RFID reader cannot distinguish the data stream as anything but authentic. It is possible to mitigate the effectiveness of a replay attack through software means at a system level however it is unlikely that such an attack can be eliminated.

The replay attack may be effectively combated if the tag and reader are designed as a system such that at each authentication event the data stream sent to the reader changes, and the actual authentication data is hidden from casual interrogation by password protection of the memory. Many common RFID chips carry on board memory structure that facilitates this methodology. In particular for HF (13.56 MHz) RFID tags the I-Code SLI-S, chip from NXP Semiconductors and for UHF (902-928 MHz) RFID tags the Alien Higgs 3 chip from Alien Technologies are examples.

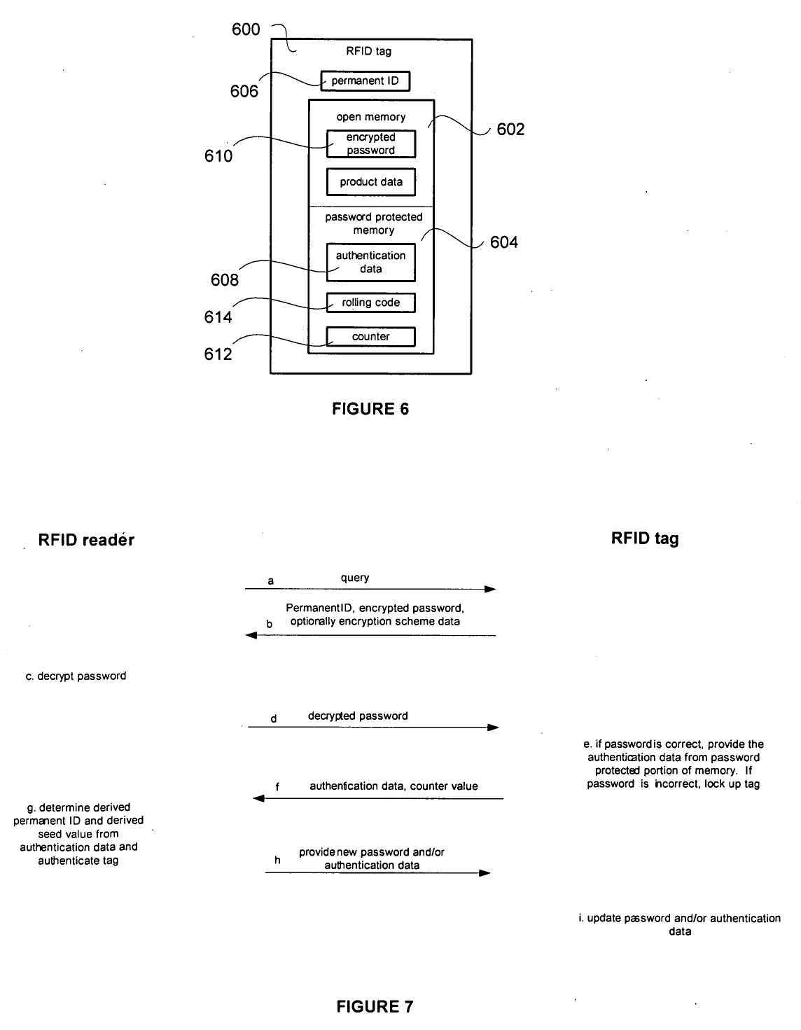

FIG. 6 shows an RFID tag 600 comprising an RFID antenna, an RFID chip using an open memory section 602 and a password protected memory section 604. The open memory section 602 can store an encrypted password 610 for the password protected memory section. The password protected section can store authentication data 608 calculated using a seed value and a permanent ID 606 of the RFID tag. The RFID tag 602 can send the encrypted password 610 to a reader and if the reader sends the decrypted password to the RFID tag 600, the authentication data 608 can be sent to the RFID reader.

The RFID tag 600 can lock up if the wrong password is sent to it.

The RFID tag 600 can further include a counter 612 that is incremented, as part of an updating process. The counter can be incremented to indicate that the password or authentication data is changed.

The RFID tag 600 can include rolling code 614.

One embodiment is a method including reading an encrypted password from a RFID (Radio Frequency Identification) tag. The password can be decrypted and sending the decrypted password sent to the RFID tag. If the password is correct, authentication data can be received from the RFID tag. The RFID tag can be authenticated using the authentication tag. The RFID tag can then be instructed to update.

The RFID tag can be given a new password, new authentication data, or both, in the instructing step.

The authentication data can be calculated using a seed value and a permanent ID of the RFID tag.

The authentication data can be encrypted.

The authentication data can be used to obtain a derived permanent ID that is compared to the permanent ID of the RFID tag.

The authentication can include reading data off of a RFID chip of an RFID tag, the data including a permanent ID put on the RFID chip by the RFID chip manufacturer, and the authentication data.

FIG. 7 shows an example where an RFID reader queries the RFID tag. The RFID tag responds with an encrypted password from an open section of the RFID tag memory. The RFID reader can decrypt the password and provide the decrypted password to the RFID tag. If the password is correct, authentication data can be provided from the password protection section of the RFID tag memory. If the password is wrong, the RFID tag can lock up.

The authentication data can be used to decide a derived permanent ID and derived seed value to authenticate the RFID tag as described above.

The password and/or authentication data on the RFID tag can then be updated.

The technique disclosed herein is referred to as a rolling code approach and may be generalized in two embodiments. In the first the tag memory is password protected and the memory contains authentication data structured similarly to the example above. The data is changed with every authentication event. The memory is segmented into two sections, a publicly accessible memory segment and a password protected memory segment. In the publicly accessible memory segment the password for access to the password protected area is written in an encrypted form. The authentication data, similarly to above, is written in the password protected section of memory. Additional data consisting of the instructions for iterating the data (rolling code) and an iterative counter which records the number of authentication events is also written in the password protection segment of memory. The password is encrypted using the authenticating authority's public encryption key. Upon interrogating a tag the authenticating reader can perform the following operations:

1) Read the encrypted password from the publicly accessible memory

2) Decrypt the password and use it to access the password protected memory of the chip

3) Read the memory content of the password protected memory segment

4) Decrypt the memory content and authenticate the tag as described above

5) Iterate the content of the of the memory, counter and authentication data.

Optionally one may also iterate the password for memory access and rewrite the password. While it is possible to maintain a single password for a group of tags, it is desirable for each tag to have a unique password.

In one embodiment the encrypted data for the password may encoded using an asymmetric encryption scheme such that the encrypted data is a mathematical combination of the tag TID and the tag password (there are no constraints on the mathematical operation other than it must be invertible). The authenticating RFID reader uses the decryption key (public key) to decrypt and extract the password.

In another embodiment the password may be encoded using a symmetric encryption scheme such that the encrypted data is a mathematical combination of the tag TID and the tag password. The authenticating RFID reader uses the decryption key to decrypt and extract the password.

In either embodiment, after a successful authentication event the reader may re-encrypt a different password and write this to the tag, as well as change the content of the authentication data that is in the password protected memory. In this embodiment the instructions for iterating the data may be contained in a specific data location. These instructions may take the form of the coefficients of a polynomial that is used to calculate the new value(s), the seed data for a Psuedo Random Number Generator (PRNG), or an index to a suitable calculation algorithm chosen by the user and stored on the authenticating reader.

The set of algorithms that may be used is broad, the selection criteria for use is defined by the system architect and must be carefully chosen to result in unique and easily invertible transformation of the initial data and the result, whether that result is the iterated password or authentication data in the password protected segment of memory.

The advantage of the this “rolling code” approach is that it significantly reduces the vulnerability to replay attacks since the each combination of data used in an authentication event is unique and is not used for subsequent authentications.

The foregoing description of preferred embodiments of the present invention has been provided for the purposes of illustration and description. It is not intended to be exhaustive or to limit the invention to the precise forms disclosed. Many embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalents.

1. A method comprising:
reading an encrypted password from a RFID (Radio Frequency Identification) tag;
decrypting the password and sending the decrypted password to the RFID tag;
if the password is correct, receiving authentication data from the RFID tag;
authenticating the RFID tag using the authentication tag; and
instructing the RFID tag to update.

2. The method of claim 1, wherein the RFID tag is given a new password in the instructing step.

3. The method of claim 1, wherein the RFID tag is given new authentication data in the instructing step.

4. The method of claim 1, wherein the RFID tag is given both a new password and new authentication data in the instructing step.

5. The method of claim 1, wherein the authentication data is calculated using a seed value and a permanent ID of the RFID tag.

6. The method of claim 5, wherein the authentication data is encrypted.

7. The method of claim 5, wherein the authentication data is used to obtain a derived permanent ID that is compared to the permanent ID of the RFID tag.

8. The method of claim 1, wherein the authentication includes reading data off of a RFID chip of an RFID tag, the data including a permanent ID put on the RFID chip by the RFID chip manufacturer, and the authentication data.

9. The method of claim 8, wherein the authentication further includes decrypting the authentication value to get a combined value.

10. The method of claim 9, wherein the authentication further comprising:
analyzing the combined value to get a derived permanent ID and a derived seed value.

11. The method of claim 10, wherein the authentication further comprising:
using at least one of the derived permanent ID and the derived seed value to validate the RFID tag.

12. An RFID tag comprising:
an RFID antenna;
an RFID chip using an open memory section and a password protected memory section, the open memory section storing an encrypted password for the password protected memory section, the password protected section storing authentication data calculated using a seed value and a permanent ID of the RFID tag; and
wherein the RFID tag sends the encrypted password to the reader and if the reader sends the decrypted password to the RFID tag, the authentication data is sent to the RFID reader.

13. The RFID tag of claim 12, wherein the RFID tag locks up if the wrong password is sent to it.

14. The RFID tag of claim 12, wherein the RFID tag further includes a counter that is incremented.

15. The RFID tag of claim 14, wherein the counter is incremented to indicate that the password or authentication data is changed.

16. The RFID tag of claim 12, wherein the RFID tag includes rolling code.
